(19) United States
(12) Patent Application Publication
(10) Pub. No.: US 2021/0016315 A1
(43) Pub. Date: Jan. 21, 2021

(54) LIQUID MATERIAL SUPPLY DEVICE

(71) Applicant: IHI Rotating Machinery Engineering Co., Ltd., Tokyo (JP)

(72) Inventors: Yoshihiro YOSHIDA, Koto-ku, Tokyo (JP); Hirokazu TANAKA, Koganei-shi, Tokyo (JP)

(73) Assignee: IHI Rotating Machinery Engineering Co., Ltd., Tokyo (JP)

(21) Appl. No.: 17/040,239

(22) PCT Filed: Mar. 20, 2019
(86) PCT No.: PCT/JP2019/011817

§ 371 Date: Sep. 22, 2020

(30) Foreign Application Priority Data
Mar. 27, 2018 (JP) 2018-060335

(51) Int. Cl. B05C 11/10; B05C 5/02

(52) U.S. Cl. CPC B05C 11/10; B05C 5/02

(57) ABSTRACT

A liquid material supply device includes a supply unit that supplies a liquid material, an opening and closing discharge unit that discharges the liquid material, a discharge flow path that is connected to the supply unit and the opening and closing discharge unit, a pressure adjustment unit that adjusts an internal pressure of the discharge flow path, a pressure feed device that delivers the liquid material to the opening and closing discharge unit through the discharge flow path, and a circulation unit that is provided between the supply unit and the opening and closing discharge unit to allow the liquid material to circulate into the discharge flow path through a circulation flow path which branches from the discharge flow path.

### TECHNICAL FIELD

The present disclosure relates to a liquid material supply device that supplies a liquid material having viscosity, such as grease.

### BACKGROUND ART

It is difficult to discharge a medium viscous or high viscous liquid material such as grease in a state where the viscosity remains high. In the related art, there has been known a device that lowers the viscosity of the grease by heating and then discharges (ejects) the grease. Patent Literature 1 discloses an electric liquid dispenser with a heater. The device discharges high viscous liquid such as a hot melt adhesive.

### CITATION LIST

### Patent Literature

Patent Literature 1: Japanese Unexamined Patent Publication No. 2001-300404

### SUMMARY OF INVENTION

### Technical Problem

As in the technique of the related art, when a heating device such as a heater is used to lower the viscosity of the liquid material, the device is increased in size and is also disadvantageous in terms of cost. In addition, there are also liquid materials that deteriorate with heating. When the liquid material deteriorates with heating, components separated from the liquid material may adhere to the tip of a discharge port. Therefore, the present disclosure describes a liquid material supply device that, with a simple configuration, space saving and low cost, can discharge various liquid materials of different viscosities in a state suitable for discharge.

### Solution to Problem

According to one aspect of the present disclosure, there is provided a liquid material supply device that discharges a liquid material having viscosity, the device including: a supply unit that supplies the liquid material; an opening and closing discharge unit that discharges the liquid material; a discharge flow path that is connected to the supply unit and the opening and closing discharge unit; a pressure adjustment unit that adjusts an internal pressure of the discharge flow path; a pressure feed device that delivers the liquid material to the opening and closing discharge unit through the discharge flow path; and a circulation unit that is provided between the supply unit and the opening and closing discharge unit to allow the liquid material to circulate into the discharge flow path through a circulation flow path which branches from the discharge flow path.

### Effects of Invention

According to one aspect of the present disclosure, with a simple configuration, space saving and low cost, various liquid materials of different viscosities can be discharged in a state suitable for discharge. In addition, a deterioration of the liquid material by heating or the separation of the liquid material can be prevented.

### BRIEF DESCRIPTION OF DRAWINGS

FIG. 1 is a cross-sectional view illustrating a schematic configuration of a liquid material supply device according to one embodiment of the present disclosure.

### DESCRIPTION OF EMBODIMENTS

According to one aspect of the present disclosure, there is provided a liquid material supply device that discharges a liquid material having viscosity, the device including: a supply unit that supplies the liquid material; an opening and closing discharge unit that discharges the liquid material; a discharge flow path that is connected to the supply unit and the opening and closing discharge unit; a pressure adjustment unit that adjusts an internal pressure of the discharge flow path; a pressure feed device that delivers the liquid material to the opening and closing discharge unit through the discharge flow path; and a circulation unit that is provided between the supply unit and the opening and closing discharge unit to allow the liquid material to circulate into the discharge flow path through a circulation flow path which branches from the discharge flow path.

According to the liquid material supply device, the pressure of the liquid material delivered through the discharge flow path by the pressure feed device is adjusted to a predetermined pressure by the pressure adjuster. The liquid material delivered to the discharge flow path is discharged from the opening and closing discharge unit. The inside of the discharge flow path can be maintained in a high pressure state by such a mechanism including the pressure adjustment unit. When the liquid material flows through the discharge flow path, the viscosity of the liquid material is temporarily lowered. Thereafter, the liquid material circulates from the discharge flow path through the circulation flow path into the discharge flow path. Due to the circulation of the liquid material, the viscosity of the liquid material inside the liquid material supply device is made uniform and is stabilized to become in a state suitable for discharge. As a result, the liquid material can be suitably discharged from the opening and closing discharge unit. In addition, according to the liquid material supply device, the liquid material can be ejected onto an object located at a predetermined distance from the opening and closing discharge unit. The viscosity of the liquid material that is discharged to adhere to the object is recovered over the elapse of time to return to the original viscosity. Since the liquid material supply device of the present disclosure does not require a heating device, the liquid material supply device can prevent a deterioration of the liquid material by heating. Since only the pressure feed device, the pressure adjustment unit, and the opening and closing discharge unit described above are provided, the configuration is simple. Therefore, the liquid material supply device can realize space saving and low cost. With a simple configuration, space saving and low cost, the liquid material supply device can discharge various liquid materials of different viscosities in a state suitable for discharge.

The pressure adjustment unit may be provided for the circulation flow path of the circulation unit. In this case, the circulation flow path downstream of the pressure adjustment unit (on a supply unit side) is held at a relatively low pressure. When the liquid material circulates in the circulation flow path in a low pressure state, the liquid material is unlikely to deteriorate, and a state where the viscosity of the liquid material is uniform and stable is held.

The pressure adjustment unit may have a structure to allow the liquid material to flow in a direction from the discharge flow path toward the circulation flow path when the internal pressure of the discharge flow path exceeds a predetermined pressure.

A rectification portion that has a larger cross-sectional area than a cross-sectional area of the circulation flow path to suppress generation of bubbles in the liquid material may be provided in a middle of the circulation flow path. In this case, since the rectification portion is provided, the liquid material can be discharged without the generation of bubbles in the liquid material.

The pressure feed device may include a reciprocating member that reciprocates in the discharge flow path, and a drive source that drives the reciprocating member in a reciprocating manner.

The discharge flow path may include a first discharge flow path which is connected to the supply unit, a second discharge flow path which communicates with the first discharge flow path and from which the circulation flow path branches, and a third discharge flow path that communicates with the second discharge flow path and is connected to the opening and closing discharge unit. A part of the liquid material passing through the second discharge flow path may return to the first discharge flow path through the circulation flow path, and the liquid material flowing to the third discharge flow path through the second discharge flow path may be discharged from the opening and closing discharge unit.

The supply unit may include a storage tank including a storage space that stores the liquid material.

Hereinafter, an embodiment of the present disclosure will be described with reference to the drawings. Incidentally, in the description of the drawings, the same components are denoted by the same reference signs and duplicated descriptions will be omitted.

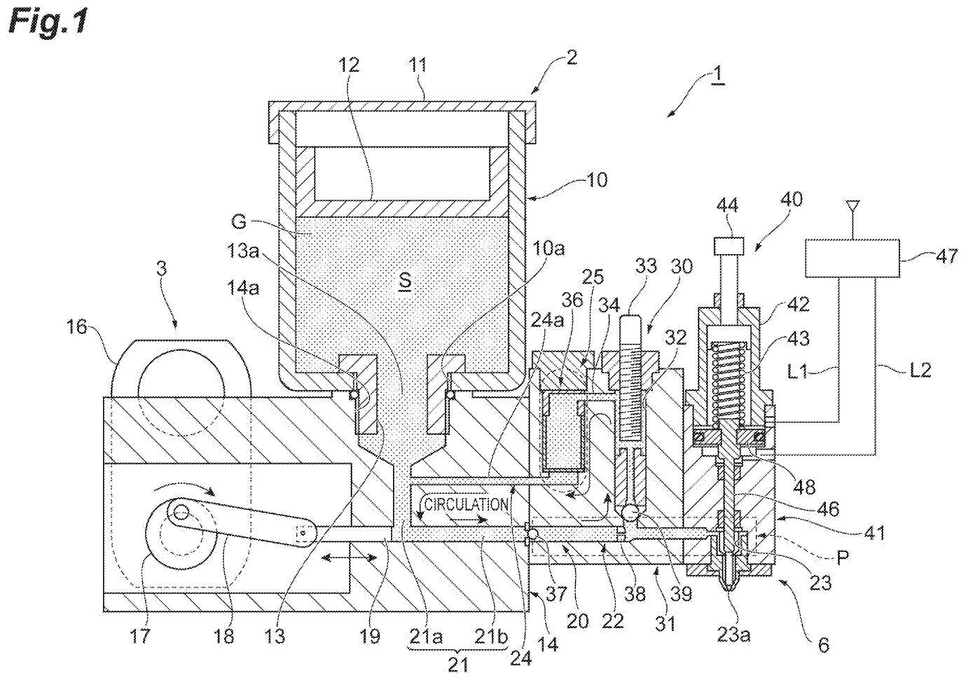

A grease supply device 1 according to one embodiment of the present disclosure will be described with reference to FIG. 1. As illustrated in FIG. 1, the grease supply device 1 is a liquid material supply device that discharges grease G which is a liquid material having viscosity. The grease supply device 1 discharges (ejects) the grease G onto an object to which the grease G is to be applied. The grease supply device 1 is a device that has a simpler configuration and can realize more space saving than the device of the related art. Naturally, the grease supply device 1 having a simple configuration can also reduce the cost. The grease supply device 1 is a small dispenser that an operator can hold with the hand.

The grease supply device 1 includes a storage tank 2 (supply unit) that supplies the grease G, and a pump unit 3 (pressure feed device) that delivers the grease G stored in the storage tank 2. In addition, the grease supply device 1 includes an opening and closing discharge unit 6 that discharges the grease and a discharge flow path 20 that is connected to the storage tank 2 and the opening and closing discharge unit 6.

The storage tank 2 as a supply unit includes a tank main body 10 having, for example, a cylindrical shape such as a circular cylindrical shape. A storage space S that can store a predetermined amount of the grease G is provided inside the tank main body 10. The storage space S of the tank main body 10 may be continuously or intermittently replenished with the fresh grease G of an amount corresponding to the amount of the grease G consumed by the grease supply device 1. A follower plate 12 is provided inside the tank main body 10 so as to cover a liquid surface of the grease G. The follower plate 12 is a sealing lid that seals the storage space S. The follower plate 12 includes a disk portion, and the disk portion is in close contact with the liquid surface of the grease G. Therefore, the follower plate 12 can also be used to pressurize the grease G. A cover portion 11 is attached to an opening formed in an upper portion of the tank main body 10. An opening 10a is formed at the center of a bottom portion of the tank main body 10, and an outflow pipe 13 having a circular cylindrical shape is fitted into the opening 10a. A gap between an outer periphery of the outflow pipe 13 and the opening 10a is sealed by a gasket, an O-ring, or the like, so that a leakage of the grease G is prevented.

The pump unit 3 is connected to a lower portion of the storage tank 2. The lower portion of the storage tank 2 is provided with a casing 14 where a first discharge flow path 21 through which the grease G passes is formed. The casing 14 is disposed below the tank main body 10, and the outflow pipe 13 described above is fitted into an opening 14a formed in an upper portion of the casing 14. The casing 14 also serves as a base (groundsill) that supports the storage tank 2. The first discharge flow path 21 formed in the casing 14 includes a communication path 21a that is connected to an outflow path 13a of the outflow pipe 13 to extend in an upward and downward direction, and a discharge path 21b that is connected to a lower end of the communication path 21a to extend in a horizontal direction. The first discharge flow path 21 communicates with the storage space S of the storage tank 2 via the outflow path 13a of the outflow pipe 13. In the specification, the “upward and downward direction” is a direction where an axis of the tank main body 10 and the outflow pipe 13 extends. The “horizontal direction” is a direction where a plunger (reciprocating member) 19 of the pump unit 3 reciprocates. The first discharge flow path 21 extends in an L shape inside the casing 14.

The grease supply device 1 includes the discharge flow path 20 connected to the storage tank 2 and the opening and closing discharge unit 6. The discharge flow path 20 includes the first discharge flow path 21, and a second discharge flow path 22 and a third discharge flow path 23 which will be described later. In addition, the grease supply device 1 includes a pressure adjustment unit 30 that adjusts the internal pressure of the discharge flow path 20.

The pump unit 3 includes a motor unit (drive source) 16 that is disposed on a lateral side of the storage tank 2, a crank portion 17 that is rotated by the motor unit 16, the plunger 19 that reciprocates in the first discharge flow path 21, and a rod portion 18 that couples the crank portion 17 and the plunger 19 to transmit the rotation force of the crank portion 17 to the plunger 19. When the motor unit 16 drives the plunger 19 in a reciprocating manner, the pump unit 3 delivers the grease G to the opening and closing discharge unit 6 through the discharge flow path 20. The plunger 19 is provided to be able to reciprocate in the discharge path 21b of the first discharge flow path 21. The motor unit 16 drives the plunger 19 in a reciprocating manner in the discharge path 21b. The motor unit 16 is, for example, an electric drive source. However, the drive source of the pump unit 3 is not limited to the motor unit 16 that is an electric type, and the plunger 19 may be driven by, for example, pneumatic pressure or the like. The motor unit 16 of the pump unit 3 has certain power or more so as to be able to apply a desired pressure to the grease G.

The pressure adjustment unit 30 is connected to the discharge flow path 20, and is disposed on a lateral side of the pump unit 3 and the storage tank 2. The pressure adjustment unit 30 adjusts the pressure of the grease G delivered from the pump unit 3, so that a high pressure state is created inside the pressure adjustment unit 30. The pressure adjustment unit 30 adjusts the pressure of the grease G in the second discharge flow path 22. The second discharge flow path 22 is formed inside a main body portion 31, which is provided adjacent to the casing 14, to extend in the horizontal direction to be connected to the discharge path 21b of the first discharge flow path 21. A central axis of the second discharge flow path 22 may coincide with a central axis of the discharge path 21b of the first discharge flow path 21. A hole portion 32 which extends in the upward and downward direction and into which a pressure adjustment screw 33 is inserted is formed in the main body portion 31. A lower end of the hole portion 32 is connected to a middle portion of the second discharge flow path 22, and a connecting portion between the hole portion 32 and the second discharge flow path 22 is provided with a check valve 39. The check valve 39 prevents a backflow of the grease G from the hole portion 32 to the second discharge flow path 22. Furthermore, the check valve 39 includes an elastic member (unillustrated). Until the pressure of the second discharge flow path 22 exceeds a predetermined pressure, the check valve prevents a flow from the second discharge flow path 22 to the hole portion 32 by virtue of the elastic force of the elastic member. The pressure adjustment screw 33 adjusts the elastic force of the elastic member to adjust the internal pressure of the second discharge flow path. The pressure adjustment unit 30 including the hole portion 32 and the pressure adjustment screw 33 brings a high pressure application region P including the second discharge flow path 22 into a high pressure state of, for example, 30 MPa or more. Incidentally, the pressure value (pressure range) that is adjustable by the pressure adjustment unit 30 can be appropriately changed. The pressure adjustment unit 30 may be able to adjust the pressure of the grease G of the high pressure application region P in a range of 20 to 40 MPa.

A connecting portion between the second discharge flow path 22 and the first discharge flow path 21 is provided with a discharge check valve 37 that prevents a backflow of the grease G. The discharge check valve 37 prevents a backflow of the grease G from the second discharge flow path 22 to the discharge path 21b of the first discharge flow path 21. A check valve 38 that limits the flow rate of the grease G is provided slightly upstream (on the left side in the drawing and a discharge check valve 37 side) of the connecting portion between the second discharge flow path 22 and the hole portion 32 in the second discharge flow path 22.

The pressure adjustment unit 30 having the above configuration adjusts the pressure of the grease G to a desired high pressure to deliver the grease G through the second discharge flow path 22. Incidentally, the pressure adjustment unit 30 is not limited to being configured to include the pressure adjustment screw 33 and the hole portion 32 described above, and other pressure adjustment mechanisms may be used.

The opening and closing discharge unit 6 is connected to the pressure adjustment unit 30, and is disposed on a lateral side of the pressure adjustment unit 30. Namely, in the grease supply device 1, the pump unit 3, the storage tank 2 attached to the pump unit 3, the pressure adjustment unit 30 connected to the pump unit 3, and the opening and closing discharge unit 6 connected to the pressure adjustment unit 30 are integrated, so that a compact device easy to handle is realized. The opening and closing discharge unit 6 receives the grease which is held in a high pressure state by the pressure adjustment unit 30, to discharge the grease G from a grease discharge port 23a. The opening and closing discharge unit 6 includes a main body portion 41 that is provided adjacent to the main body portion 31 of the pressure adjustment unit 30, and an opening and closing valve 40 that can open and close the grease discharge port 23a. The third discharge flow path 23 extending in the upward and downward direction is formed in a lower portion of the main body portion 41, and the grease discharge port 23a described above is provided at a lower end of the third discharge flow path 23.

The third discharge flow path 23 communicates with the second discharge flow path 22 and is connected to the opening and closing discharge unit 6. The opening and closing valve 40 includes a valve body 46 that opens and closes the grease discharge port 23a, and a cylinder portion 42 that is attached to an upper portion of the main body portion 41. A spring 43 that applies force in a direction to close the valve body 46 is provided inside the cylinder portion 42. In addition, the cylinder portion 42 is provided with a discharge port opening and closing time and discharge flow rate adjustment valve 44 that regulates the opening and closing time of the valve body 46. The opening and closing time of the grease discharge port 23a is regulated by the discharge port opening and closing time and discharge flow rate adjustment valve 44. The opening and closing valve 40 further includes an annular body 48 that is fitted onto the periphery of the main body portion 41 to be movable in an axial direction (upward and downward direction) of the cylinder portion 42, a first air line L1 and a second air line L2 that are connected to both sides (upper side and lower side) of the annular body 48, and an electromagnetic valve 47 that performs switching between the first air line L1 and the second air line L2 to supply control air thereto. Compressed air is supplied from an air supply source (unillustrated) to the first air line L1 and the second air line L2. The switching control of the compressed air by the electromagnetic valve 47 allows the annular body 48 and the valve body 46 to reciprocate together in the axial direction in the main body portion 41. The valve body 46 of the opening and closing valve 40 opens and closes (repeats opening and closing) the grease discharge port 23a. When the opening and closing valve 40 opens the grease discharge port 23a, the grease G in the third discharge flow path 23 is discharged from the grease discharge port 23a at a predetermined pressure. The high pressure application region P described above includes the third discharge flow path 23 and the grease discharge port 23a. The electromagnetic valve 47 may be directly attached to the opening and closing valve 40, so that the first air line L1 and the second air line L2 are omitted.

The grease supply device 1 includes a mechanism that temporarily lowers the viscosity of the grease G to suitably discharge the grease G from the grease discharge port 23a. Moreover, the grease supply device 1 does not require such a heating device used in the dispenser of the related art. Power sources required by the grease supply device 1 are only the power source of the pump unit 3 and the compressed air required to operate the opening and closing valve 40, and other power sources are not required.

A circulation flow path 24 that connects an upper portion of the hole portion 32 of the pressure adjustment unit 30 and a middle portion of the communication path 21a of the pump unit 3 is provided in the main body portion 31 of the pressure adjustment unit 30 and the casing 14 of the pump unit 3. The circulation flow path 24 branches from the second discharge flow path 22 to be connected to the first discharge flow path 21 upstream of a branch point of the circulation flow path 24. Then, the pressure adjustment unit 30 is provided for the circulation flow path 24. The circulation flow path 24 connects the second discharge flow path 22 and the first discharge flow path 21 to allow the grease G to return from the second discharge flow path 22 to the first discharge flow path 21 via the pressure adjustment unit 30. The circulation flow path 24 allows the grease G to return, so that the grease G circulates between the opening and closing discharge unit 6 and the pump unit 3.

Namely, the pressure adjustment unit 30 described above has a structure where since the pressure adjustment unit 30 includes the check valve 39 and the pressure adjustment screw 33, when the internal pressure of the discharge flow path 20 exceeds a predetermined pressure, the pressure adjustment unit 30 allows the grease G to flow in a direction from the discharge flow path 20 toward the circulation flow path 24.

The grease supply device 1 includes a circulation unit 25 that is provided between the storage tank 2 and the opening and closing discharge unit 6 to allow the grease G circulate into the discharge flow path 20 through the circulation flow path 24 which branches from the discharge flow path 20. In the grease supply device 1, a part of the grease G passing through the second discharge flow path 22 returns to the first discharge flow path 21 through the circulation flow path 24, and the grease G flowing to the third discharge flow path 23 through the second discharge flow path 22 is discharged from the opening and closing discharge unit 6.

As illustrated in FIG. 1, the circulation flow path 24 of the circulation unit 25 includes a branch path 34 that is formed inside the main body portion 31 to be connected to the hole portion 32, a rectification portion 36 that is formed inside the main body portion 31 to be connected to the branch path 34, and a recirculation path 24a that is formed in the casing 14 of the pump unit 3 to connect the rectification portion 36 and the communication path 21a. The rectification portion 36 forms a space having a circular cylindrical shape having a larger cross-sectional area than the cross-sectional area of the circulation flow path 24, namely, the cross-sectional area of the branch path 34 or the recirculation path 24a. The branch path 34 is connected to an upper end of the rectification portion 36, and the recirculation path 24a is connected to a lower end of the rectification portion 36. The independent structure of the rectification portion 36 suppresses the generation of bubbles in the grease G.

According to the grease supply device 1 of the present embodiment, after the grease G is delivered from the first discharge flow path 21 to the second discharge flow path 22 by the pump unit 3, the grease G is delivered to the third discharge flow path 23 and the circulation flow path 24. The pressure of the grease G delivered to the second discharge flow path 22 and the third discharge flow path 23 is adjusted to a predetermined pressure by the pressure adjustment unit 30. When the opening and closing valve 40 of the opening and closing discharge unit 6 is opened, the grease G delivered to the third discharge flow path 23 is discharged from the grease discharge port 23a. The insides of the second discharge flow path 22 and the third discharge flow path 23 can be maintained in a high pressure state by such a mechanism including the pressure adjustment unit 30 and the opening and closing valve 40. When the plunger 19 reciprocates in the first discharge flow path 21, the viscosity of the grease G is temporarily lowered. In addition, when the grease G passes through the check valve 39 from the second discharge flow path 22 in a high pressure state, the viscosity of the grease G is temporarily lowered.

Thereafter, the grease G circulates from the second discharge flow path 22 into the first discharge flow path 21 through the circulation flow path 24. Due to the circulation of the grease the viscosity of the grease G in the discharge flow path 20 and the circulation flow path 24 is made uniform and is stabilized to become in a state suitable for discharge.

According to the grease supply device 1, since the insides of the second discharge flow path 22 and the third discharge flow path 23 are maintained in a high pressure state, when the opening and closing valve 40 is opened and closed, the grease G can also be ejected (fly) onto an object located at a predetermined distance from the grease discharge port 23a. The viscosity of the grease G that is discharged to adhere to the object is recovered over the elapse of time to return to the original viscosity. In the device of the related art that lowers the viscosity of the grease by heating, such recovery of the viscosity of the grease cannot be expected. Since the grease supply device 1 of the present disclosure does not require the heating device, a deterioration of the grease G by heating can be prevented from occurring and oil separated from the grease G can be prevented from adhering to the grease discharge port 23a. In addition, since only the pump unit 3, the pressure adjustment unit 30, and the opening and closing discharge unit 6 described above are provided, the configuration is simple. Therefore, the grease supply device 1 realizes space saving and low cost. Therefore, with a simple configuration, space saving and low cost, the grease supply device 1 can discharge various greases G (liquid materials) of different viscosities in a state suitable for discharge.

Since the pressure adjustment unit 30 is provided for the circulation flow path 24 of the circulation unit 25 (in the middle of the circulation flow path 24), the circulation flow path 24 downstream of the pressure adjustment unit 30 (on a storage tank 2 side) is held at a relatively low pressure. When the grease G circulates in the circulation flow path 24 in a low pressure state, the grease G is unlikely to deteriorate, and a state where the viscosity of the grease G is lowered is held. Unlike the present embodiment, if the grease (liquid material) circulates in the circulation flow path in a high pressure state, there is a possibility that the liquid material is separated and deteriorates. On the other hand, in the present embodiment, since the liquid material circulates in the circulation flow path 24 in a low pressure state, the liquid material is unlikely to deteriorate and the lowered viscosity is maintained.

Since the rectification portion 36 that suppresses the generation of bubbles is provided in the middle of the circulation flow path 24, when the grease G passes through the rectification portion 36, the lowered viscosity is held more uniform to become in a state more suitable for discharge. The grease G can be discharged without the generation of bubbles in the grease G.

There are a wide variety of the greases G. In the grease supply device 1, the pressure adjustment unit 30 can adjust the pressure of the high pressure application region P according to the viscosity of the grease G. For this reason, the grease supply device 1 has high versatility for the greases G of different viscosities. Moreover, the pressure raised by the pressure adjustment unit 30 is higher than in the device of the related art.

The embodiment of the present disclosure has been described above; however, the present invention is not limited to the above embodiment. For example, the rectification portion that suppresses the generation of bubbles may be omitted. Alternatively, in order to suppress the generation of bubbles, other mechanisms different from the rectification portion may be provided. The bubble generation suppressing mechanism may be provided in the circulation flow path 24, but may be provided in any other discharge flow paths.

The above embodiment has described a case where the liquid material supply device is applied to the grease G as a liquid material; however, the present is not limited thereto, and the liquid material supply device of the present invention may be applied to liquid materials other than the grease G. For example, the liquid material supply device may be a device that supplies a medium viscous or high viscous liquid material such as an adhesive or paint.

The connection form of the circulation flow path 24 is not limited to the above embodiment. The circulation flow path 24 may be a flow path that is directly connected to the second discharge flow path 22 and the discharge path 21b of the first discharge flow path 21. The circulation flow path 24 is not limited to a case where the circulation flow path 24 is formed inside the main body portion, and may be provided as an external pipe. The rectification portion 36 may be omitted. In addition, the supply unit of the liquid material may be a mechanism that supplies the grease G from an external pipe connected to the first discharge flow path 21.

### INDUSTRIAL APPLICABILITY

According to some aspects of the present disclosure, with a simple configuration, space saving and low cost, various liquid materials of different viscosities can be discharged in a state suitable for discharge. In addition, a deterioration of the liquid material by heating or the separation of the liquid material can be prevented.

### REFERENCE SIGNS LIST

1: grease supply device (liquid material supply device), 2: storage tank (supply unit), 3: pump unit (pressure feed device), 6: opening and closing discharge unit, 16: motor unit (drive source), 19: plunger, 20: discharge flow path, 21: first discharge flow path, 22: second discharge flow path, 23: third discharge flow path, 23a: grease discharge port (discharge port), 24: circulation flow path, 25: circulation unit, 30: pressure adjustment unit, 33: pressure adjustment screw, 36: rectification portion, 40: opening and closing valve (opening and closing valve), G: grease (liquid material).

1. A liquid material supply device that discharges a liquid material having viscosity, the device comprising:
a supply unit that supplies the liquid material;
an opening and closing discharge unit that discharges the liquid material;
a discharge flow path that is connected to the supply unit and the opening and closing discharge unit;
a pressure adjustment unit that adjusts an internal pressure of the discharge flow path;
a pressure feed device that delivers the liquid material to the opening and closing discharge unit through the discharge flow path; and
a circulation unit that is provided between the supply unit and the opening and closing discharge unit to allow the liquid material to circulate into the discharge flow path through a circulation flow path which branches from the discharge flow path.

2. The liquid material supply device according to claim 1,
wherein the pressure adjustment unit is provided for the circulation flow path of the circulation unit.

3. The liquid material supply device according to claim 1,
wherein the pressure adjustment unit has a structure to allow the liquid material to flow in a direction from the discharge flow path toward the circulation flow path when the internal pressure of the discharge flow path exceeds a predetermined pressure.

4. The liquid material supply device according to claim 1,
wherein a rectification portion that has a larger cross-sectional area than a cross-sectional area of the circulation flow path to suppress generation of bubbles in the liquid material is provided in a middle of the circulation flow path.

5. The liquid material supply device according to claim 1,
wherein the pressure feed device includes a reciprocating member that reciprocates in the discharge flow path, and
a drive source that drives the reciprocating member in a reciprocating manner.

6. The liquid material supply device according to claim 1,
wherein the discharge flow path includes a first discharge flow path which is connected to the supply unit, a second discharge flow path which communicates with the first discharge flow path and from which the circulation flow path branches, and a third discharge flow path that communicates with the second discharge flow path and is connected to the opening and closing discharge unit, and
a part of the liquid material passing through the second discharge flow path returns to the first discharge flow path through the circulation flow path, and the liquid material flowing to the third discharge flow path through the second discharge flow path is discharged from the opening and closing discharge unit.

7. The liquid material supply device according to claim 1,
wherein the supply unit includes a storage tank including a storage space that stores the liquid material.
